(19) United States
(12) Patent Application Publication
(10) Pub. No.: US 2009/0288691 A1
(43) Pub. Date: Nov. 26, 2009

(54) SOLAR PANEL CLEANING SYSTEM

(76) Inventors: Gene C. Hunt, Palm Desert, CA (US); Michael D. Workman, Palm Desert, CA (US)

Correspondence Address: STETINA BRUNDA GARRED & BRUCKER, 75 ENTERPRISE, SUITE 250, ALISO VIEJO, CA, 92656, US

(21) Appl. No.: 12/126,194

(22) Filed: May 23, 2008

(51) Int. Cl. B08B 3/00

(52) U.S. Cl. 134/57 R; 134/18

(57) ABSTRACT

A solar power cleaning system is provided including a fluid supply line. A first end of the fluid supply line is utilized for receiving water. A second end of the fluid supply line is coupled to a plurality of nozzles for dispensing fluid onto solar panels. The cleaning system also includes a housing. Disposed within the housing is a valve for regulating soap from a storage compartment into the fluid supply line. The valve is controlled by a programmable controller. When the valve is open, soap mixes with water and is dispensed onto the solar panels via the nozzles. When the valve is closed, water may be dispensed onto the solar panels. A filter may be coupled to the fluid supply line to remove impurities from the water before dispensation onto the solar panels. A motor and pump may also be disposed within the housing to regulate the fluid pressure within the fluid supply line.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field of the Invention

The present invention relates generally to a cleaning system and, more particularly, to an automatic solar panel cleaning system for maximizing potential efficiency.

2. Description of the Related Art

The growing interest in climate change has renewed interest in renewable and sustainable energy sources. These renewable energy sources include solar, wind, hydroelectricity, biomass, and bio-fuels. In the past, these renewable energy sources were not economically feasible. Additionally, people were hesitant to invest in renewable sources of energy when other non-renewable energy sources were extremely affordable. Fortunately, the advancement in various technologies has seen the cost of renewable energy sources decrease. Simultaneously, global prices for non-renewable energy have increased. One example is the cost of oil. Additionally, many governments that control a vast amount of non-renewable energy sources are unstable and susceptible to implode which may have a drastic effect on the supply of non-renewable energy sources that will certainly fall short of the increasingly growing demand. Therefore, renewable energy sources may eventually replace non-renewable forms of energy as the main source of energy for the world population.

It appears that solar power has a great potential for replacing a vast quantity of non-renewable energy sources as the main source of energy. The amount of energy absorbed by the earth from sunlight in one day is more energy than is used by the entire world population in one year. Solar power involves converting sunlight into electricity. The conversion of sunlight into electricity is made possible by photovoltaic cells. Based on technology that is available today, photovoltaic panels (solar panels) are capable of converting approximately 15% of incident sunlight into electricity. However, the rate at which sunlight is converted into electricity appears to be gradually on the rise. With the advancement of technology and time, solar panels may likely be able to substantially increase the percentage conversion of sunlight into electricity while remaining economically feasible. Application of solar power may be applied to residential, commercial, industrial, agricultural, and transportation industries. Solar energy can be used to produced food, heat, light, and electricity.

Although it appears that the ability of solar panels to convert sunlight into electricity will be accomplished at a more efficient rate, there are elements that have an adverse effect on the efficiency of the solar panel irrespective of the photovoltaic cell. For example, if the solar panels are covered, the efficiency of the solar panel may decrease. Depending on the location of the solar panels and the environment there are various elements that may have an adverse effect on the solar panels efficiency of converting sunlight into electricity. These elements may include dirt, grime, bird droppings and airborne contaminants. Additionally, in cold climates snow or ice that is allowed to cover the solar panel may have an adverse effect. These and many other elements contribute to the reduction in efficiency of solar power generated by solar panel systems.

Geographical location, current weather, panel mounting angles, smog, bird droppings and instances of airborne particle emissions all contribute to creating dirty solar panels. Due to these variables there is no fixed percentage reduction that is a constant. Experts disagree on the amount of power lost due to dirty solar panels, but all agree that there is a reduction of solar power. Estimates have ranged between 10%-70% reduction in maximum efficiency due to dirty or covered solar panels. Given the collective effort of many government bodies, activists, and corporations to create alternative sources of energy, any reduction in maximum output potential is wasteful.

A well known method to remove dirt and other elements while maximizing the potential efficiency of solar panels and preventing a decrease in efficiency, is to clean the solar panels. Presently, solar panels may be cleaned in a similar manner as cleaning a window panel. However, because solar panels are sometimes located in hard to reach areas such as on a slanted rooftop, the chore of climbing to the rooftop to clean a solar panel system is burdensome and often times dangerous. Additionally, some solar panel systems include a large quantity of individual solar panels. Cleaning each individual solar panel may consume too much time. Thus, a few desired qualities for a solar panel cleaning system may include a system capable of cleaning solar panels in hard to reach places and the ability to clean in a timely and efficient manner.

Therefore, there is a need in the art for a solar panel cleaning system. This need is addressed by the present invention, as will be described in more detail below.

### BRIEF SUMMARY

The present invention specifically addresses and alleviates the above-identified deficiencies in the art. The present invention is directed to a solar panel cleaning system. The solar panel cleaning system includes a fluid supply line. The fluid supply line has a first end attached to a water supply source. The first end of the fluid supply line receives water from the water supply source. The fluid supply line also includes a second end. The second end has a plurality of nozzles coupled to the fluid supply line. The plurality of nozzles are capable of receiving the fluid within the fluid supply line for dispensing the fluid onto the solar panels. The solar panel cleaning system also includes a housing. The housing receives a portion of the fluid supply line. Disposed within the housing is a storage compartment. The storage compartment may include soap used to wash the solar panels. The solar panel cleaning system also includes a valve used to connect or link the storage compartment to the fluid supply line. When the valve is in an open position, soap from the storage compartment is allowed to flow to the fluid supply line. When soap flows into the fluid supply line it is mixed with water to create a cleaning fluid. When the valve is in the closed position, soap is prevented from flowing to the fluid supply line. A programmable controller is in electrical communication with the valve. The programmable controller positions the valve to either the open or the closed valve position.

An aspect of the present invention contemplates a water filter coupled to the fluid supply line. The water filter is used to remove impurities from the water supplied by the water supply source. In accordance with the present invention, a fluid flow valve may also be disposed within the housing. The fluid flow valve is coupled to the fluid supply line and regulates the flow of water within the fluid supply line. The programmable controller is in electrical communication with the fluid flow valve to control the fluid flow valve position. When the fluid flow valve is open, water is allowed to flow past the fluid flow valve. Alternatively, when the fluid flow valve is closed, water is prevented from flowing past the fluid flow valve. Another valve may also be coupled to the fluid supply line. A drain valve is in electrical communication with the programmable controller. The programmable controller may control the opening and closing of the drain valve. The drain valve is connected to a drain outlet and directs fluid to the drain outlet when the drain valve is open. It is contemplated that the drain valve may open when the plurality of nozzles complete dispensing fluid onto the solar panels.

In another embodiment in accordance with the present invention, the solar panel cleaning system includes a pump and a motor. Both the pump and the motor are disposed within the housing. The pump is mechanically coupled to the motor. The motor is in electrical communication with the programmable controller. Upon receiving an electrical signal from the programmable controller, the motor may actuate the pump. The pump is designed to regulate the fluid pressure within the fluid supply line. It is contemplated that both the programmable controller and the motor are powered by a power supply source. In one embodiment, the power supply source used to power both the motor and the programmable controller is the solar panel system.

In yet another embodiment of the present invention, a plurality of zone control valves are used to regulate the supply of fluid to a set of nozzles. Each zone control valve is used to control a particular set of nozzles. The zone control valves are coupled to the second end of the fluid supply line and are in electrical communication with the programmable controller. It is also contemplated that there is at least a one to one ratio of nozzles to solar panels. Therefore, for each solar panel there is at least one nozzle that dispenses fluid onto the solar panel. Another embodiment also contemplates a water heater disposed within the housing. The water heater may be used to heat the water flowing within the fluid supply line. This allows the nozzles to dispense heated water onto the solar panels. Additionally, a wetting agent may also be added to the fluid supply line. The programmable controller may be programmed such that the solar panel cleaning system functions automatically. In this respect, the programmable controller is configured so that a mixture of water and soap is dispensed from the nozzles onto the solar panels. Subsequently, the mixture is rinsed off by dispensing only water from the nozzles.

The present invention is also directed to an automated method for cleaning a solar panel system. The method includes receiving water from a water supply source via a fluid supply line. The fluid supply line has a first end for receiving water from the water supply source. A second end of the fluid supply line dispenses fluid onto a plurality of solar panels using nozzles that are coupled to the fluid supply line. The method continues by transmitting an electrical signal from a programmable controller to a soap valve for opening the soap valve. When the soap valve is open, soap may be injected into the fluid supply line from a storage compartment. After the soap is injected into the fluid supply line, the nozzles coupled to the fluid supply line may dispense a mixture of water and soap onto the solar panels. A second electrical signal is then received by the soap valve and the soap valve closes. When the soap valve is closed, soap is prevented from being injected into the fluid supply line. The method may then continue by dispensing water from the plurality of nozzles onto the solar panels.

In another embodiment of the present invention, a filter is coupled to the fluid supply line for removing impurities within the water supplied by the water supply source. An aspect of the present invention contemplates regulating the fluid pressure within the fluid supply line. A pump is coupled to the fluid supply line and used to regulate the fluid pressure within the fluid supply line. The pump is mechanically coupled to a motor configured to actuate the pump upon receiving an electrical signal from the programmable controller. The programmable controller is also in communication with a plurality of zone control valves. Each zone control valve is configured to regulate the fluid dispensed from a set of nozzles. It is contemplated that the plurality of nozzles are segregated into different sets that define a zone or section. The method may also include heating the fluid within the fluid supply line prior to dispensing the fluid via the nozzles.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic diagram of a solar panel cleaning system constructed in accordance with the present invention;

FIG. 2 is another embodiment depicting the solar panel cleaning system; and

FIG. 3 is a perspective view of a nozzle mounted on a bracket and angled toward a solar panel constructed in accordance with the present invention.

### DETAILED DESCRIPTION

The above description is given by way of example, and not limitation. Given the above disclosure, one skilled in the art could devise variations that are within the scope and spirit of the invention disclosed herein, including various ways of configuring the solar panel cleaning system. Further, the various features of the embodiments disclosed herein can be used alone, or in varying combinations with each other and are not intended to be limited to the specific combination described herein. Thus, the scope of the claims is not to be limited by the illustrated embodiments.

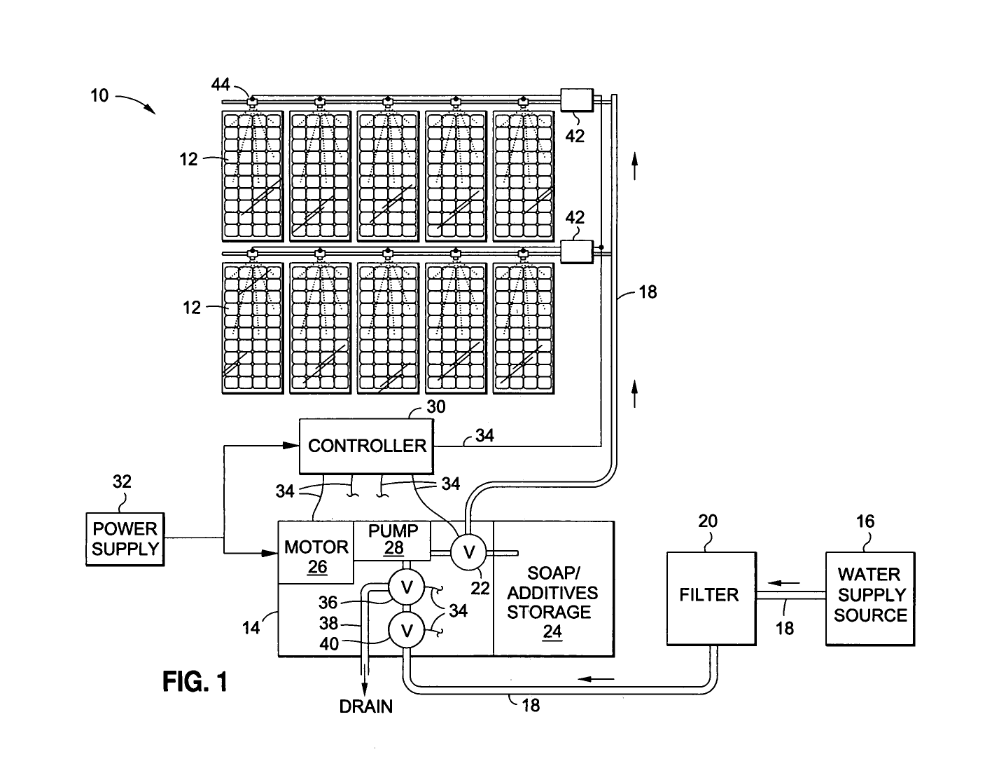

With reference to FIG. 1, a schematic of the solar panel cleaning system 10 is provided. In one embodiment constructed in accordance with the present invention, the solar panel cleaning system 10 is a fixed system configured to connect to a water supply source 16. In a residence or private home the water may be supplied from a hose bib. The water supply source 16 is connected to the solar panel cleaning system 10 via a fluid supply line 18. The fluid supply line 18 is configured to receive water from the water supply source 16 and direct the water to a plurality of nozzles 44. Those skilled in the art will recognize that the material utilized for the fluid supply line 18 may include: copper, polyvinyl chloride (PVC), flexible plastic or stainless steel. The suggested materials are by way of example only and not meant to limit the type of materials to be used for the fluid supply line 18. An aspect of the present invention contemplates the fluid supply line 18 forming a pipe for directing fluid flow. The fluid supply line 18 may include an incoming and an outgoing end. The incoming end is the portion of the fluid supply line 18 that receives water from the water supply source 16. The outgoing end is the portion of the fluid supply line 18 in communication with the plurality of nozzles 44 for dispensing fluid from the fluid supply line 18. In one embodiment of the present invention, using a flexible plastic material for the outgoing end of the fluid supply line 18 may be preferred because it provides for added flexibility when installing the solar panel cleaning system 10 associated with various solar panel configurations.

Guiding the received water from the water supply source 16 to the plurality of nozzles 44 for dispensing fluid onto a solar panel 12 or a group of solar panels may result in hard water spotting on the solar panel 12. Mineral spotting may build over time by directing unfiltered water onto the solar panel 12. The mineral spotting is an undesired result because it may adversely affect the absorption of sunlight by the photovoltaic cells disposed within the solar panel 12. To avoid hard water spotting a filter 20 may be installed. An aspect of the present invention contemplates the filter 20 being coupled to the fluid supply line 18. The filter 20 is capable of removing impurities within the water from the water supply source 16 prior to the water being dispensed by the plurality of nozzles 44 onto the solar panels 12. The filter 20 is designed to be removable and replaceable. The filter 20 is designed to minimize hard water spotting on the solar panels 12 caused from impurities such as minerals. The filter 20 may be a dual filter. In this regard, the filter 20 includes a softening resin filter and a phosphate crystal filter. Additionally, the size of the filter 20 is dependent on the size of the solar panels 12 that are a part of the solar panel system of which the solar panel cleaning system 10 is used to clean. For example, if the solar panel system to be cleaned includes large panels or a vast quantity of panels more water will be required for cleaning. If more water is required, a larger filter is necessary.

The fluid supply line 18 is received by a housing 14. The housing 14 portion of the solar panel cleaning system 10 may house various elements used to alter certain attributes of the received water flowing within the fluid supply line 18. An aspect of the present invention contemplates a flow valve 40 disposed within the housing 14. The flow valve 40 is coupled to the portion of the fluid supply line 18 received by the housing 14. When the flow valve is open, water flowing within the fluid supply line 18 is allowed to pass through the flow valve 40. When the flow valve 40 is closed, water flowing within the fluid supply line 18 is prevented from flowing past the flow valve 40. The flow valve 40 position is controlled by a programmable controller 30. The programmable controller 30 is in electrical communication with the flow valve 40 via a low voltage wire 34. The flow valve 40 is configured to receive an electrical signal from the programmable controller 30. The flow valve 40 changes positions based upon the received electrical signal. For example, the flow valve 40 may be calibrated such that when it receives an electrical signal having a current of 4 amperes, the flow valve 40 will remain open. When the electrical signal is representative of a 20 ampere current, the flow valve may be calibrated to close. It is contemplated that when the solar panel cleaning system 10 is shut off, the flow valve 40 is closed. Alternatively, when the solar panel cleaning system 10 is on, a continuous flow of water may be required; therefore the flow valve 40 should be in the open position.

The programmable controller 30 may be affixed to the outer portion of the housing 14. In another embodiment of the present invention, the programmable controller 30 is separate from the housing 14. The programmable controller 30 is connected to a power supply source 32. The power supply source 32 may be an outlet, a generator, or any other applicable power supply source. It is contemplated that the programmable controller 30 is powered by a 110-Volt incoming power supply. The power supply source 32 used to power the programmable controller 30 may be the solar panel system. In this respect, the programmable controller 30 of the solar panel cleaning system 10 receives power from the solar panel system. This can be accomplished through various known methods a person skilled in the art would use to make compatible the power generated from the solar panels 12 to provide power to the programmable controller 30. Therefore, the solar panel system that is cleaned is also used to provide the power to the programmable controller 30 for control and operation of the solar panel cleaning system 10.

A drain valve 36 may also be disposed within the housing 14. The drain valve is connected to a drain outlet 38 for exhausting fluid from the housing 14. The drain valve 36 is also coupled to the fluid supply line 18. When the drain valve 36 is in a closed position, fluid passing the drain valve 36 is not diverted from the fluid supply line 18 to the drain outlet 38. When the drain valve 36 is in an open position, fluid flowing from the fluid supply line 18 through the drain valve 36 is diverted to the drain outlet 38 and subsequently exhausted from the housing 14. The drain valve 36 may typically be used to exhaust fluid within the fluid supply line 18 when the solar panel cleaning system 10 is initially shut off. The fluid that remains within the fluid supply line 18 may be exhausted via the drain valve 36 and the drain outlet 38.

The programmable controller 30 is in electrical communication with the drain valve 36. It is contemplated that the programmable controller 30 is connected to the drain valve 36 via low voltage wire 34. The drain valve 36 is configured to receive an electrical signal from the programmable controller 30. The electrical signal is processed by the drain valve 36 to determine the desired position. The communication between the drain valve 36 and the programmable controller 30 is similar to that of the flow valve 40 and the programmable controller 30. Thus, the drain valve 36 may alternate positions based upon the current value of the electrical signal. It is also contemplated that the drain valve 36 may exhaust fluid utilizing a gravity feed system. When a gravity feed system is utilized, the drain valve 36 is not required to be in electrical communication with the programmable controller 30.

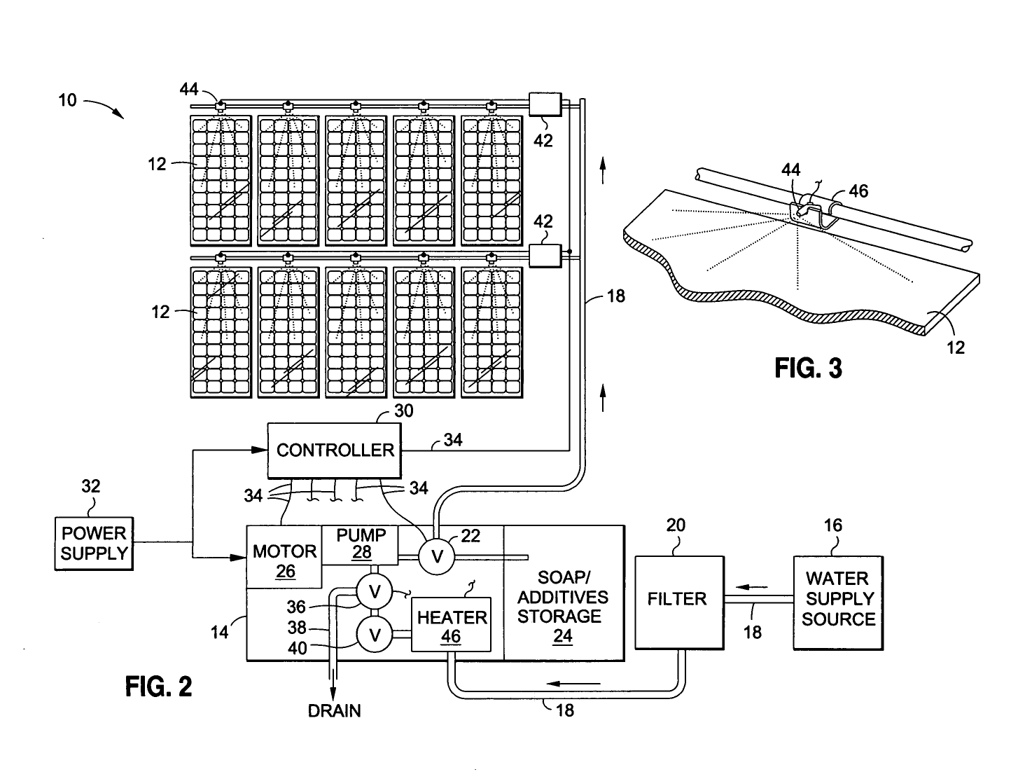

Referring now to FIG. 2, the housing 14 is provided including a water heater 46. In cool climates sheets of ice or snow covering the solar panel 12 may drastically reduce the efficiency of the solar panel 12. It is contemplated that the water heater 46 is coupled to the fluid supply line 18. The water heater 46 receives water flowing within the fluid supply line 18. The water may then be heated and directed back to the fluid supply line 18. Thus, heated water may be dispensed onto the solar panels 12 via the plurality of nozzles 44 for melting ice or snow that has accumulated on the surface of the solar panels 12. The programmable controller 30 is in electrical communication with the water heater 46 via low voltage wires 34. The water heater 46 temperature may be set at the programmable controller 30. The programmable controller is in electrical communication with the water heater 46 and configured to switch the water heater 46 on and off. The solar panel 12 efficiency may be reduced up to 70% because of ice and snow that may prevent the photovoltaic cells disposed within the solar panels 12 from absorbing energy from sunlight. Therefore, in cool climates the ability to dispense heated water to melt snow or ice allow for the solar panels to operate more efficiently.

Referring back to FIG. 1, the housing 14 may also include a storage compartment 24. The storage compartment 24 may function as a soap reservoir for the solar power cleaning system 10. It is contemplated that soap within the storage compartment 24 is refillable. The storage compartment 24 is coupled to the fluid supply line 18. The storage compartment 24 is configured to dispense or inject soap into the fluid supply line 18. The soap from the storage compartment 24 and the water within the fluid supply line 18 are mixed to form a cleaning solution within the fluid supply line 18. The cleaning solution may then be dispensed onto the solar panels 12 via the plurality of nozzles 44. The soap entering the fluid supply line 18 is regulated by a valve 22. The valve 22 is used to connect the storage compartment 24 to the fluid supply line 18. In other words, when the valve 22 is open, soap may be injected into the fluid supply line 18. However, when the valve 22 is closed, soap from the storage compartment 24 is prevented from entering the fluid supply line 18 by the valve 22.

The valve 22 is controlled by the programmable controller 30. The programmable controller is in electrical communication with the valve 22. Upon receiving an electrical signal from the programmable controller 30, the valve 22 may either move to an open position or a closed position. The valve 22 may be calibrated such that an electrical signal having a particular current value will cause the valve 22 to open and allow soap to be injected into the fluid supply line 18. An electrical signal having a different current value, may cause the valve 22 to move to or remain in the closed position thereby preventing soap from entering the fluid supply line 18. The automation of the solar panel cleaning system 10 is handled by the programmable controller 30. For example, the programmable controller 30 during a washing cycle may instruct the flow valve 40 and the valve 22 to maintain an open position. As a result, water and soap are mixed in the fluid supply line 18 to form the cleaning solution and the cleaning solution is dispensed onto the solar panels 12 via the plurality of nozzles 44. Subsequently, the programmable controller 30 may automatically switch to a rinse cycle with respect to a timing circuit associated with the programmable controller 30. During the rinse cycle, the flow valve 40 remains open while the valve 22 is closed. This results in water being dispensed onto the solar panels 12 to rinse off the cleaning solution.

The storage compartment 24 disposed within the housing 14 may also include a wetting agent. It is contemplated that the wetting agent is stored within the storage compartment 24 but kept separate from the soap. The wetting agent may be injected into the fluid supply line 18 and mixed with the water within the fluid supply line 18. This mixture is contemplated to prevent or minimize water spotting on the surface of the solar panels 12. The supply of the wetting agent from the storage compartment 24 may be regulated by a wetting agent valve or the same valve 22 regulating the supply of soap to the fluid supply line 18. The wetting agent valve may be controlled by the programmable controller 30 similar in manner in which the valve 22 is controlled. It is also contemplated that the wetting agent may be provided in a second storage compartment separate from the soap storage compartment 24.

A motor 26 and pump 28 may also be disposed within the housing 14 of the solar panel cleaning system 10. The motor 26 may be an electric motor mechanically coupled to the pump 28. The motor 26 is in electrical communication with the programmable controller 30. It is contemplated that low voltage wires 34 are used to connect the programmable controller 30 and the motor 26. The motor 26 is configured to receive an electrical signal from the programmable controller 30. In response to receiving the electrical signal, the motor 26 actuates the pump 28. The pump 28 is coupled to the fluid supply line 18. Therefore, when the pump is actuated, the fluid pressure within the fluid supply line 18 may be adjusted or modified. In one embodiment, it is contemplated that the pump 28 may increase fluid pressure within the fluid supply line 18 between 100 to 250 pounds per square inch (psi).

The requisite fluid pressure within the fluid supply line 18 may be a function of various different variables corresponding to the solar panel system to be cleaned. These variables may include: the number of solar panels 12, the length of the fluid supply line 18 from the pump 28 to the plurality of nozzles 44, and the availability of water from the water supply source 16. For example, if the solar panels 12 are located on a rooftop of a residence, the fluid supply line 18 may be connected to the water supply source 16 at the ground level. Therefore, greater fluid pressure within the fluid supply line 18 is necessary to pump water such that the water is elevated within the fluid supply line 18 from ground level to the rooftop of the residence where the fluid is dispensed onto the solar panels 12. Alternatively, if the fluid supply line 18 is at the same level as the solar panels 12 such as ground level, the fluid pressure may not require much boost by the pump 28. However, other factors such as the size and quantity of the solar panels may also be incorporated when determining the suggested fluid pressure within the fluid supply line 18. It is contemplated that the fluid pressure provided by the pump 28 is regulated at the programmable controller 30.

The fluid supply line 18 is used to direct the flow of water or cleaning solution to the solar panels 12. The fluid supply line 18 supplies the plurality of nozzles 44 with fluid for dispensing onto the solar panels 12. An aspect of the present invention contemplates the use of zone control valves 42. The zone control valves 42 are used to regulate the fluid to a set of nozzles in a particular area or zone. The zone control valves 42 are in electrical communication with the programmable controller 30 and connected to the programmable controller 30 via low voltage wires 34. The quantity of solar panels designated per zone may be dependent upon water pressure available at installation. The typical pressure available in a standard house plumbing system is approximately 5 to 8 gallons per minute. The amount of water per nozzle varies, depending on the nozzle necessary to provide necessary flow to clean and rinse. Panel size, mounting orientation, mounting angles and geographical locations impact nozzle selection as well as the number of nozzles necessary. For example, each zone control valve 42 may regulate the distribution of fluid to a zone consisting of five solar panels. In this regard, the programmable controller 30 may control which zone of solar panels 12 will be cleaned. The programmable controller 30 may be programmed to alternate cleaning between different zones of solar panels 12. It is also contemplated that certain solar panels 12 within a particular zone may be cleaned without having to clean the other solar panels within the same zone. The zone control valve 42 may be calibrated such that the electrical signal received from the programmable controller 30 corresponds to the zone control valve 42 dispensing fluid from one nozzle 44 for cleaning one solar panel 12. A plurality of combinations may be developed for cleaning different zones of solar panels via the zone control valves 42 and programming the programmable controller 30.

It is contemplated that power is transmitted from the programmable controller 30 on low voltage 24-volt AC multi-bundle lines. The programmable controller 30 similar to the motor 26 receives power from an incoming power supply. In one embodiment this may include a 110-volt power supply. In another embodiment, the power supply may be provided directly from the solar panel system utilizing any well known method to a person skilled in the art to ensure the power generated from the solar panel system is compatible with the programmable controller 30. For example, this may include utilizing an inverter to convert DC to AC. However, other well known methods are contemplated. In this scenario, the solar panel system is used to power the solar power cleaning system 10.

The ratio of nozzles 44 to solar panels 12 may vary. The solar panel cleaning system 10 contemplates at least one nozzle being used to clean at least one solar panel 12. Referring briefly to FIG. 3, the nozzles 44 may be mounted on a bracket 46 such that the nozzle is pointed at a downward angle toward the solar panel 12. The bracket 46 may be configured such that the height of the nozzle 44 is adjustable. Additionally, the angle at which the nozzle 44 is directed may also be configurable. It is also contemplated that the nozzle 44 is placed in a position wherein the fluid dispensed is capable of reaching most if not all areas of the solar panel 12. The position may be adjusted according to preference. The adjustments may take into consideration whether the solar panels 12 are tilted at an angle or flat. Mounting locations are calculated depending on water pressure, mounting configuration and number of nozzles per zone control valve 42. It is preferred that the nozzle 44 is placed in a location where the cleaning fluid may easily target the entire area of the solar panel 12. Another embodiment in accordance with the present invention contemplates using a sliplock or pushlock connector for coupling each nozzle to the fluid supply line 18. For example, the sliplock connector is configured to receive two fluid supply lines 18 running perpendicular to each other or forming an upside down T shape. One of the fluid supply lines 18 may then be coupled to the solar panel 12 using small brackets or mounting clips. A nozzle body and the nozzle 44 may then be coupled to the distal end of the fluid supply line 18 that is coupled to the solar panel 12. In this respect, the height of the nozzle 44 is dependent on the length of the portion of the fluid supply line 18 extending from the sliplock connector and coupled to the solar panel 12. Utilizing sliplock and/or pushlock connectors to couple same size or different sized fluid supply lines 18 provides for easy and quick installation. Additionally, such materials are inexpensive yet very effective and durable.

The solar panel cleaning system 10 including the programmable controller 30 may be programmed to function automatically or manually as is suitable for the solar panel system. Further, the solar panel cleaning system 10 is highly adaptable for various solar panel systems. The solar panel cleaning system 10 provides the user with the option to select a manual mode to clean and rinse the solar panels 12 or to rinse only without the use of soap. The solar panel cleaning system 10 can be designed for solar panels located on rooftops, ground-mounted or any fixed solar panel application. The solar panel cleaning system 10 may also be installed on solar tracking system mounting applications. Although the solar panel cleaning system 10 is described as utilized for solar panels 12, the solar panel cleaning system 10 may be used with solar attic fans, solar tube lights and any other fixed panel system including glass windowpanes.

Furthermore, the various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention.

What is claimed is:

1. A solar panel cleaning system, comprising:
a fluid supply line for directing fluid flow to a plurality of solar panels, the fluid supply line having a first end and a second end, the first end configured to receive water from a water supply source, the second end coupled to a plurality of nozzles for dispensing fluid from the fluid supply line onto a plurality of solar panels;
a housing configured to receive the fluid supply line;
a storage compartment disposed within the housing, the storage compartment configured to supply soap to the fluid supply line;
a valve connecting the storage compartment to the fluid supply line, the valve configured to regulate the supply of soap from the storage compartment to the fluid supply line dependent upon a valve position, a valve open position allows the flow of soap into the fluid supply line, a valve closed position prevents the flow of soap into the fluid supply line; and
a programmable controller in electrical communication with the valve for regulating the valve position.

2. The system of claim 1, further comprising a water filter coupled to the fluid supply line for removing impurities from the water received by the water supply source.

3. The system of claim 1, further comprising a fluid flow valve disposed within the housing, the fluid flow valve is coupled to the fluid supply line for regulating fluid flow within the fluid supply line in response to receiving an electrical signal from the programmable controller.

4. The system of claim 1, further comprising a drain valve disposed within the housing, the drain valve is coupled to the fluid supply line for draining fluid from the fluid supply line via a drain outlet.

5. The system of claim 1, further comprising:
a pump disposed within the housing, the pump coupled to the fluid supply line for regulating fluid pressure within the fluid supply line; and
a motor disposed within the housing, the motor mechanically coupled to the pump, the motor being in electrical communication with the programmable controller, the motor actuating the pump in response to receiving an electrical signal from the programmable controller.

6. The system of claim 5, wherein the incoming power supply to the programmable controller and the motor is provided by the solar power generated by the plurality of solar panels to be cleaned by the solar panel cleaning system.

7. The system of claim 1, further comprising:
a plurality of zone control valves coupled to the fluid supply line, each zone control valve configured to regulate fluid supplied by the fluid supply line to a set of nozzles from the plurality of nozzles, the programmable controller being in electrical communication with the plurality of zone control valves for regulating the operation of each zone control valve.

8. The system of claim 1, wherein each solar panel receives fluid dispensed from at least one nozzle.

9. The system of claim 1, further comprising a water heater disposed within the housing, the water heater being coupled to the fluid supply line for supplying heated water.

10. The system of claim 1, further comprising a second storage compartment, the second storage compartment coupled to the fluid supply line for supplying a wetting agent to the fluid supply line.

11. The system of claim 1, wherein the programmable controller is set to an automated mode, the automated mode comprising:
dispensing a mixture of water and soap from the plurality of nozzles; and
rinsing the mixture of water and soap by dispensing water from the plurality of nozzles.

12. An automated method for cleaning a solar panel system, the method comprising:
receiving water from a water supply source via a fluid supply line, the fluid supply line having a first end and a second end, the first end being configured to receive water from the water supply source, the second end having a plurality of nozzles for dispensing fluid from the fluid supply line;
transmitting an electrical signal from a programmable controller to a soap valve for opening the soap valve;
injecting soap from a storage compartment to the fluid supply line via the open soap valve;
dispensing a mixture of water and soap from the fluid supply onto at least one solar panel using at least one nozzle from the plurality of nozzles coupled to the fluid supply line;
receiving a second electrical signal from the programmable controller for closing the soap valve; and
dispensing water on at least one solar panel using at least one nozzle.

13. The method of claim 12, wherein each solar panel from the solar panel system to be cleaned receives fluid dispensed from at least one nozzle.

14. The method of claim 12, further comprising:
removing impurities from the water supplied by the water supply source using a filter coupled to the fluid supply line.

15. The method of claim 12, further comprising:
regulating the fluid pressure within the fluid supply line using a pump, the pump being mechanically coupled to a motor, the motor configured to receive an electrical signal from the programmable controller for actuating the pump.

16. The method of claim 12, further comprising:
transmitting an electrical signal from the programmable controller to a plurality of zone control valves, each zone control valve being configured to regulate the fluid dispensed from a set of nozzles in response to receiving the electrical signal from the programmable controller.

17. The method of claim 11, further comprising:
heating the water within the fluid supply line using a water heater for dispensing heated water via the plurality of nozzles.

18. The method of claim 11, further comprising:
draining fluid within the fluid supply line via a drain valve coupled to a drain outlet, the drain valve being in electrical communication with the programmable controller for opening the drain valve.

19. The method of claim 14, wherein the power supplied to the motor and the programmable controller is provided by the solar panel system.

20. The method of claim 11, further comprising:
injecting a wetting agent into the fluid supply line via a second valve controlled by the programmable controller.
